(19) United States
(12) Patent Application Publication
(10) Pub. No.: US 2026/0361239 A1
(43) Pub. Date: Nov. 12, 2026

(54) ECOH-LOCKED PIEZO-MAGNETOSTRICTIVE SPIRAL VIBRATION HARVESTER

(71) Applicant: Jonathan Washburn, Austin, TX (US)

(72) Inventor: Jonathan Washburn, Austin, TX (US)

(21) Appl. No.: 19/672,196

(22) Filed: May 8, 2026

Related U.S. Application Data
(60) Provisional application No. 63/804,588, filed on May 12, 2025.

(51) Int. Cl. H02N 2/18

(52) U.S. Cl. CPC H02N 2/188; H02N 2/181

(57) ABSTRACT

A vibration energy harvester includes a cantilever structure configured to exhibit multiple resonant responses, with at least two resonant responses related by phi; a piezoelectric transducer and a magnetostrictive transducer mechanically coupled to the cantilever structure; a pickup structure inductively coupled to the magnetostrictive transducer; and an energy extraction circuit configured to receive harvested energy from the piezoelectric and magnetostrictive transducers and to release output energy only when accumulated harvested energy reaches an integer multiple of a coherence quantum E_coh=phi\hat{ }(−5). In some implementations, the cantilever is a logarithmic phi-spiral cantilever having a beam-width taper, and the energy extraction circuit includes an energy accumulator, a threshold detector or carry detector, a switched-capacitor transfer circuit, and an output stage. Release events may be synchronized to an eight-tick cadence.

### CROSS-REFERENCE TO RELATED APPLICATIONS

This application claims priority to U.S. Provisional Patent Application No. 63/804,588, filed on May 12, 2025, entitled “Ecoh-Locked Piezo-Magnetostrictive Spiral Vibration Harvester,” the entire contents of which are incorporated herein by reference in their entirety.

### BACKGROUND

The present disclosure relates generally to vibration energy harvesting and, more particularly, to broadband vibration energy harvesters employing a cantilever structure configured to exhibit multiple resonant responses, at least two of said resonant responses being related by phi, dual piezoelectric and magnetostrictive transduction, and quantized energy extraction. In preferred implementations, the disclosure further relates to low-noise and quantum-compatible energy harvesting architectures in which extracted energy is constrained to integer multiples of a coherence quantum and, in some implementations, synchronized to an eight-tick cadence.

Vibration energy harvesting converts ambient mechanical motion into electrical power for low-power electronics, including wireless sensor nodes, structural health monitoring devices, industrial monitoring systems, wearable electronics, and other distributed loads. Existing vibration harvesters, however, suffer from substantial technical limitations.

Conventional piezoelectric vibration harvesters are typically narrowband. Piezoelectric cantilevers formed from materials such as lead zirconate titanate and aluminum nitride can achieve useful power density near resonance, but their conversion efficiency drops sharply when excitation moves off resonance. As a result, broadband operation commonly requires multiple separately tuned cantilevers or complex tuning mechanisms, increasing device size, fabrication cost, and packaging complexity.

Magnetostrictive harvesters can respond over a broader frequency range, but frequently produce relatively low voltages that require boost circuitry or other power-conditioning electronics that reduce overall efficiency. While magnetostrictive materials can be attractive for strain-responsive energy harvesting, many standalone implementations are difficult to deploy in compact, efficient systems.

Prior hybrid piezoelectric and magnetostrictive harvesters generally treat the two transduction paths as separate or parallel channels rather than as a mechanically integrated shared-stress-field architecture. As a result, prior hybrid systems often fail to exploit the full combined benefit of both transduction mechanisms acting on the same strain event.

Conventional broadband mechanical harvesters commonly trade Q factor for bandwidth. A narrow, high-Q resonator can exhibit strong peak response but poor bandwidth, while broadband devices often spread response at the expense of peak efficiency. This creates a persistent bandwidth-versus-performance tradeoff.

Conventional harvesters are not designed for co-location with quantum-sensitive electronics or other low-noise systems. Continuous or arbitrarily timed extraction and associated electrical noise can disturb nearby sensitive circuitry. Prior art systems generally do not provide a structured extraction rule intended to reduce such perturbations.

Conventional harvesters also extract arbitrary continuous amounts of energy without regard to a quantized extraction rule. The present disclosure departs from such approaches by using an energy extraction architecture configured to release output energy only in integer multiples of a coherence quantum E_coh=phi\hat{ }(−5), as described in greater detail below.

Accordingly, there remains a need for a vibration energy harvester that provides broadband response without sacrificing resonant performance, that combines piezoelectric and magnetostrictive conversion in a truly shared mechanical architecture, and that supports structured quantized energy extraction suitable for low-noise operation.

### SUMMARY

The present disclosure provides a vibration energy harvester comprising a cantilever structure configured to exhibit multiple resonant responses, at least two of said resonant responses being related by phi; a piezoelectric transducer mechanically coupled to the cantilever structure; a magnetostrictive transducer mechanically coupled to the cantilever structure; a pickup structure inductively coupled to the magnetostrictive transducer; and an energy extraction circuit configured to receive harvested energy from the piezoelectric transducer and the magnetostrictive transducer and to release output energy only when accumulated harvested energy reaches an integer multiple of a coherence quantum E_coh=phi\hat{ }(−5). The disclosure also provides corresponding methods of harvesting vibration energy using the foregoing architecture.

In preferred implementations, the cantilever structure is implemented as a logarithmic phi-spiral cantilever having a beam-width taper, adjacent resonant responses related to phi, and, in more specific implementations, resonant mode frequencies satisfying f_n=f_0×phi\hat{ }n. In preferred implementations, the piezoelectric transducer and the magnetostrictive transducer are coupled to a same stress field in the cantilever structure. In preferred implementations, the energy extraction circuit includes an energy accumulator, a threshold detector or carry detector, a switched-capacitor transfer circuit configured to transfer discrete energy packets according to a phi-based transfer ratio, a serializer or queue configured to sequence a plurality of release events, and an output stage. In further preferred implementations, extraction events are synchronized to an eight-tick cadence.

The disclosed architecture is scalable across MEMS, industrial, wearable, cryogenic, and other implementations, and may employ representative piezoelectric materials including PZT, AlN, PVDF, and PMN-PT and representative magnetostrictive materials including Terfenol-D, Galfenol, Metglas, and FeCoSiB. Additional details of structure, operation, validation, and representative embodiments are set forth below.

### BRIEF DESCRIPTION OF THE FIGURES

FIG. 1 is a plan view of a cantilever structure configured for phi-related multi-mode response and implemented as a logarithmic phi-spiral cantilever, showing a clamp region, a spiral cantilever beam, a proof mass, a beam-width taper profile, and representative geometric parameters.

FIG. 2 is a cross-sectional view of a dual-transduction stack, showing a piezoelectric transducer, a structural cantilever substrate, a magnetostrictive transducer, a pickup structure, and representative shared-strain paths through the stack.

FIG. 3 is a frequency-response diagram showing multiple resonant responses of a cantilever structure, with at least two resonant responses related by phi and narrower implementations satisfying a golden-ratio modal relationship.

FIG. 4 is a functional block diagram of an E_coh-locked extraction circuit, showing piezoelectric and magnetostrictive inputs, an energy accumulator, a threshold detector or carry detector, a switched-capacitor transfer circuit configured for phi-based discrete packet transfer, a watchdog, an optional timing source, and an output stage.

FIG. 5 is a representative performance plot showing output power as a function of vibration input level.

FIG. 6 is a flowchart of a method of harvesting vibration energy using phi-related resonance, dual transduction, quantized energy accumulation, and integer-multiple energy release.

FIG. 7 is a schematic view of a MEMS-scale embodiment and a corresponding fabrication sequence.

FIG. 8 is a schematic view of a macro-scale industrial embodiment.

FIG. 9 is a schematic view of a flexible wearable embodiment.

FIG. 10 is a schematic view of a cryogenic embodiment.

### DETAILED DESCRIPTION

The present disclosure provides a vibration energy harvester in which a cantilever structure configured to exhibit multiple resonant responses, at least two of said resonant responses being related by phi, is combined with a same-stress dual transduction arrangement and a coherence-locked extraction architecture in a single energy harvesting system. The disclosure is directed to the integrated harvester architecture first and then to representative operating sequences and representative embodiments demonstrating how the invention may be made and used, with corresponding method aspects following from operation of the disclosed structure.

As used herein, the term phi refers to the golden ratio, phi=(1+sqrt(5))/2. As used herein, the term cantilever structure refers to a vibration-responsive structural member that is fixed or constrained at one region and free to deflect at another region under mechanical excitation. As used herein, the phrase related by phi refers to phi relationships, including modal relationships determined by measurement, simulation, design selection, or combinations thereof. As used herein, the term same stress field means that a piezoelectric transducer and a magnetostrictive transducer are both mechanically coupled to the same bending or strain event in the cantilever structure, such that a common deformation of the cantilever structure is converted by both transduction mechanisms.

As used herein, the term E_coh refers to a coherence quantum having value E_coh=phi\hat{ }(−5). In the disclosed architecture, E_coh is not treated as an arbitrary threshold selected merely for convenience. Rather, the extraction circuitry is configured so that harvested energy is accumulated and released only in integer multiples of E_coh. As used herein, the phrase integer multiple of E_coh includes a release condition in which an accumulator state, least significant bit, transfer unit, code value, or other energy-representation quantity corresponds to one or more whole-E_coh increments.

As used herein, the phrase phi-based transfer ratio refers to a capacitor ratio, charge-transfer ratio, scaling relationship, or equivalent discrete-transfer relationship selected to implement packet transfer according to phi. As used herein, the phrase imbalance threshold refers to a selected threshold associated with accumulator mismatch, packet-transfer inconsistency, timing inconsistency, or another monitored release condition. As used herein, the term eight-tick cadence refers to a preferred timing framework in which release events are aligned to one of eight permitted phase positions in a repeating cycle. Unless otherwise stated, eight-tick synchronization is a preferred operating layer and is not required in every implementation of the broader harvester architecture.

In some implementations and as optional explanatory context for the disclosed extraction architecture, the exponent 5 in E_coh=phi\hat{ }(−5) may be described through a constraint chain in which D=3, 2\hat{ }D=8, D corresponds to Fibonacci value F4=3, 2\hat{ }D corresponds to Fibonacci value F6=8, and F6−F4=F5, such that 8−3=5 and therefore E_coh=phi\hat{ }{−(2\hat{ }D−D)}=phi\hat{ }(−5). This discussion is provided as explanatory context for one way of understanding the disclosed coherence-locked extraction rule. In representative numerical framing, E_coh=phi\hat{ }(−5) is approximately 0.0902 in RS natural units, approximately 0.090 eV, and approximately 1.44×10\hat{ }−20 J. At a representative 25 mV conversion level, this corresponds to charge on the order of 576 aC. These values are provided as concrete interpretive anchors for the quantized extraction rule and not as limitations on the claimed invention.

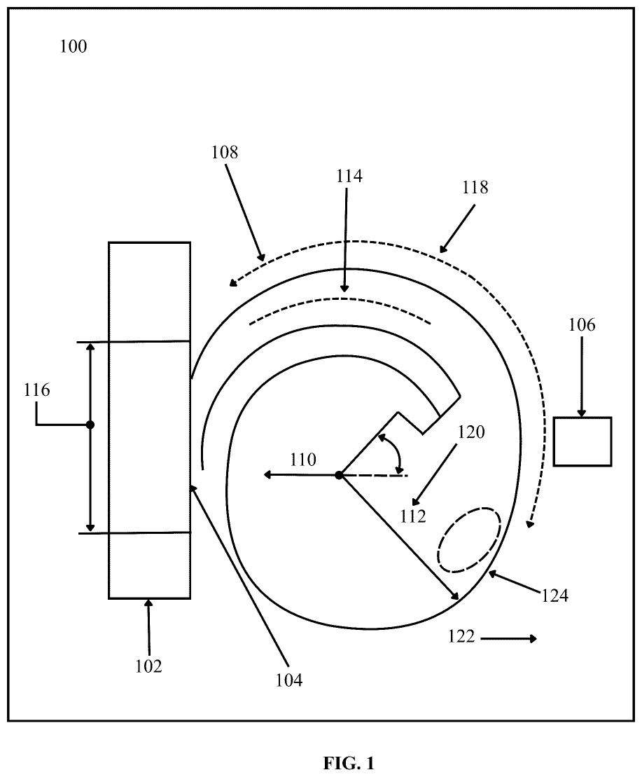

With reference generally to FIGS. 1-6, a vibration energy harvester according to the present disclosure includes a cantilever structure 100 configured to receive vibration input and to exhibit multiple resonant responses, at least two of said resonant responses being related by phi; a piezoelectric transducer and a magnetostrictive transducer mechanically coupled to the cantilever structure; a pickup structure inductively coupled to the magnetostrictive transducer; and an energy extraction circuit 400 configured to accumulate harvested energy and release output energy only in integer multiples of E_coh. In one representative integrated embodiment, mechanical vibration excites one or more resonant modes of the cantilever structure, the resulting strain is simultaneously presented to the piezoelectric and magnetostrictive transducers, electrical energy from both transduction paths is conditioned and accumulated, and a release event is permitted only when the accumulated energy satisfies an integer-multiple release condition.

FIG. 1 depicts one representative cantilever structure 100 in plan view. Cantilever structure 100 includes clamp region 102 and cantilever beam 104 extending from clamp region 102. In the illustrated implementation, cantilever beam 104 follows a logarithmic phi-spiral path. Proof mass 106 is disposed at or near a distal portion of cantilever beam 104 and may be used to tune modal response, adjust effective fundamental frequency, or increase response amplitude at selected operating bands. Beam-width taper profile 108 is defined along arc-length path 114 from base width 116 over total spiral length 118 between inner radius 110 and outer radius 112. Pitch angle reference 120 identifies a representative spiral angle, vibration input direction 122 identifies a representative excitation direction, and mode-antinode region 124 identifies a representative region of elevated modal displacement or strain. FIG. 1 therefore illustrates one preferred structural implementation of a cantilever structure configured to exhibit multiple resonant responses, with narrower implementations satisfying adjacent-response phi relationships and still narrower implementations satisfying logarithmic phi-spiral and taper-law relationships.

FIG. 2 depicts one representative transduction stack assembly 200 coupled to the cantilever structure. Piezoelectric layer 202 is disposed on or coupled to structural substrate 206 and cooperates with upper electrode 204 and lower electrode or interface region 208 to generate a piezoelectric output through piezoelectric output path 216 in response to cantilever bending. Magnetostrictive layer 210 is mechanically coupled to structural substrate 206 so that bending strain produces a magnetization change and corresponding magnetic flux variation along flux path 214. Pickup structure 212 is inductively coupled to the magnetostrictive transducer and produces an electrical output through magnetostrictive output path 218. Shared strain field 220 extends through the transduction stack so that both the piezoelectric transducer and the magnetostrictive transducer respond to a same deformation event of the cantilever structure. FIG. 2 therefore illustrates one representative same-stress dual-transduction arrangement in which both transduction mechanisms are mechanically coupled to a common strain event rather than operating as independent parallel harvesters.

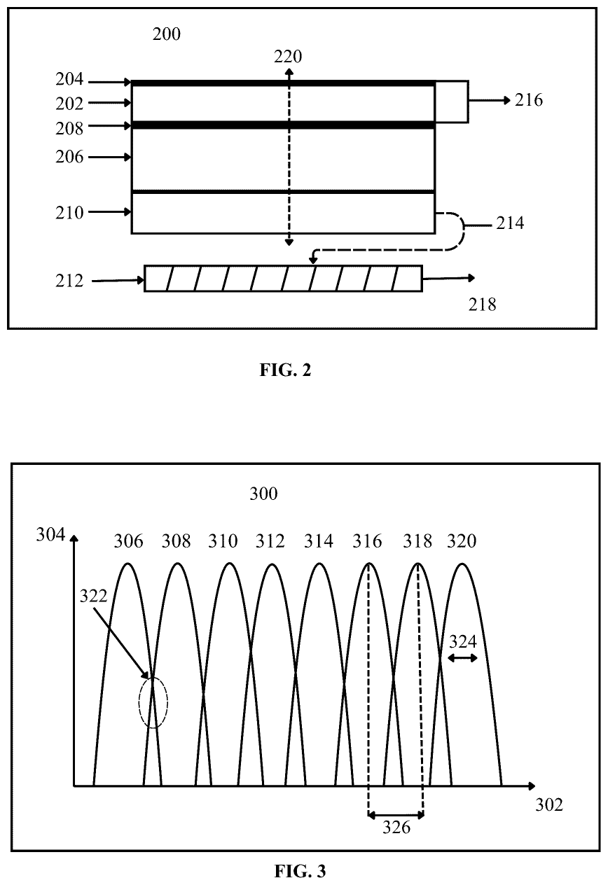

FIG. 3 depicts a representative frequency-response plot 300 for a cantilever structure according to the present disclosure. Frequency axis 302 and response amplitude axis 304 define the response space, and representative mode peaks 306, 308, 310, 312, 314, 316, 318, and 320 illustrate multiple resonant responses of the cantilever structure. Overlap region 322 shows how neighboring responses may collectively broaden usable harvesting bandwidth, representative Q marker 324 illustrates that selected implementations may preserve useful modal sharpness, and phi spacing annotation 326 indicates a representative phi-based relationship between resonant responses. FIG. 3 thus supports broader implementations in which at least two resonant responses are related by phi, preferred implementations in which adjacent responses satisfy f_(n+1)/f_n=phi, and narrower implementations in which resonant mode frequencies satisfy f_n=f_0×phi\hat{ }n.

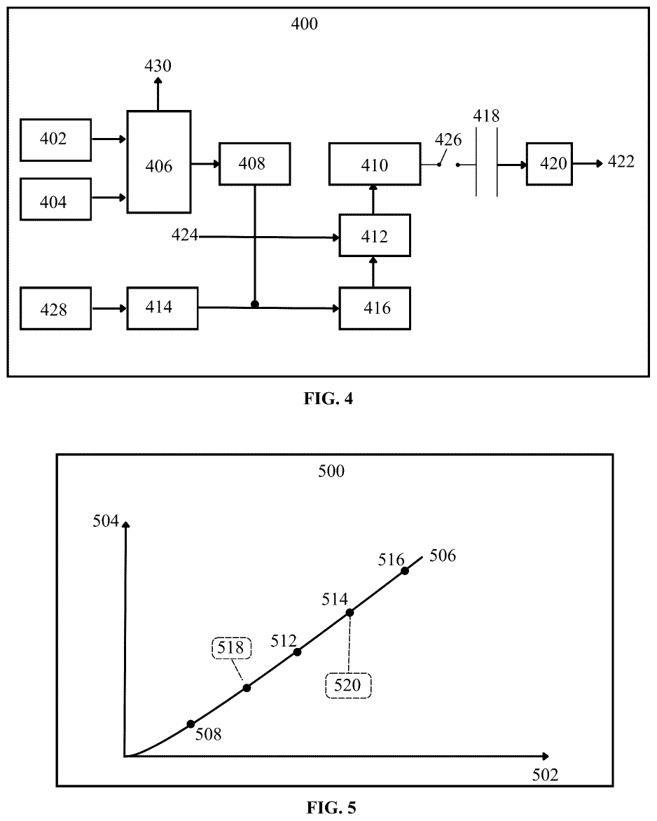

FIG. 4 depicts one representative extraction circuit assembly 400. Piezoelectric input 402 and magnetostrictive input 404 provide harvested energy from the two transduction channels. Energy accumulator 406 represents accumulated harvested energy and may be implemented as a digital, analog, mixed-signal, switched-capacitor, Delta-Sigma, charge-accounting, or other accumulation structure. Threshold detector or carry detector 408 monitors accumulator state and determines when accumulated energy reaches an integer multiple of E_coh. Switched-capacitor transfer circuit 410 transfers discrete energy packets according to a phi-based transfer ratio. Optional serializer 412 may buffer or sequence a plurality of release events. Optional watchdog 414 may monitor imbalance or release-consistency conditions and may inhibit extraction if a selected threshold is exceeded.

Optional eight-tick clock 416 provides one representative timing source for preferred synchronized implementations. Storage capacitor 418 and regulator 420 form one representative output stage delivering DC output 422. Control bus 424, disconnect switch 426, threshold monitor 428, and accumulator state output 430 illustrate representative control and monitoring paths. FIG. 4 therefore supports a representative extraction architecture including accumulator-based energy accounting, threshold or carry detection, discrete packet transfer, optional watchdog operation, and preferred timed release. In one representative operating sequence associated with FIG. 4, harvested energy increments the accumulator over successive vibration cycles, the threshold detector or carry detector identifies attainment of the integer-multiple release condition, the serializer optionally queues one or more release-ready events, and the switched-capacitor transfer circuit transfers one or more discrete packets to the storage capacitor either immediately or within a permitted eight-tick timing window, while the claimed invention remains grounded in the structural and operational harvester architecture rather than in any single explanatory framework.

FIG. 5 depicts a representative performance plot 500 showing output power as a function of vibration input level. Acceleration axis 502 and power axis 504 define the plotted variables, while power-response curve 506 and representative data points 508, 512, 514, and 516 illustrate one example of how harvested power may scale with input excitation. Optional annotations 518 and 520 may identify representative operating regions for different implementations, such as MEMS-scale and industrial embodiments. FIG. 5 is illustrative of representative device performance and may be used in validation or comparison studies, but does not limit the claimed invention to a particular absolute output level.

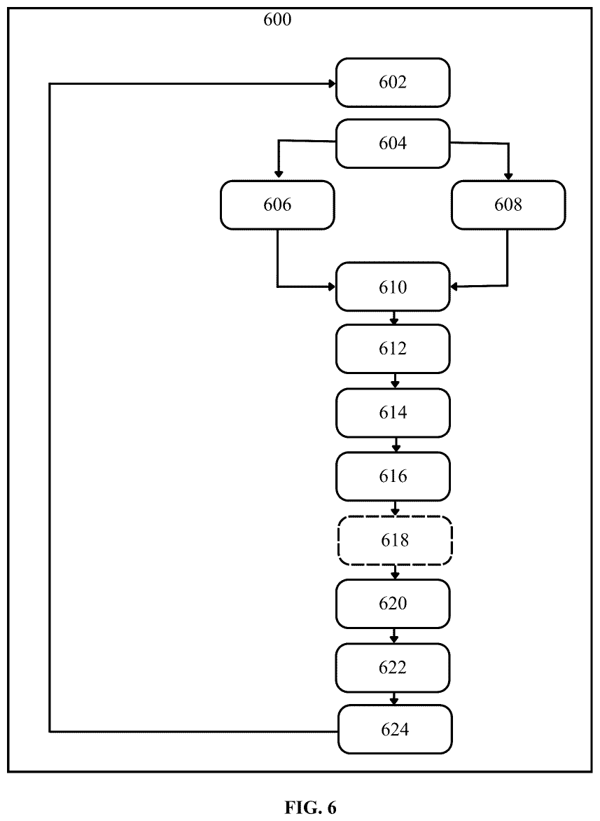

FIG. 6 depicts one representative method flow 600 for harvesting vibration energy according to the present disclosure. At step 602, vibration is received. At step 604, one or more resonant responses of the cantilever structure are excited. At step 606, a piezoelectric output is generated. At step 608, a magnetostrictive output is generated. At step 610, channel energy is combined or otherwise directed toward a common accumulation path. At step 612, harvested energy is accumulated. At step 614, the accumulator state is compared to an integer-multiple release condition. At step 616, one or more E_coh packets are released if the release condition is satisfied. At optional step 618, an eight-tick timing window is checked. At step 620, watchdog state may be updated. At step 622, output energy is delivered. At step 624, the harvesting cycle may repeat. FIG. 6 therefore supports the claimed method family and shows one representative make-and-use sequence by which the disclosed harvester may be operated.

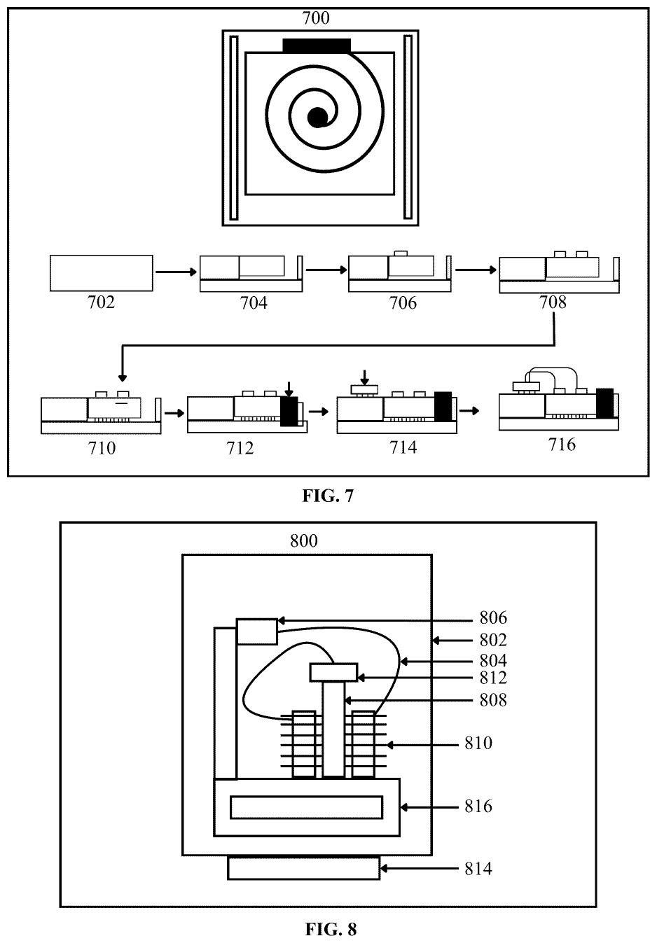

FIG. 7 depicts one representative MEMS embodiment 700 and a corresponding fabrication sequence. SOI wafer 702 or another microfabrication substrate may be used as a starting structure. Etched spiral 704 defines the cantilever geometry. Piezoelectric layer deposition 706 and magnetostrictive layer deposition 708 establish the dual-transduction arrangement. Planar coil formation 710 provides one representative pickup structure. Proof mass placement 712 provides one representative tuning structure, and integration of extraction circuitry 714 yields completed die 716.

FIG. 7 therefore illustrates one representative approach for making a MEMS-scale implementation of the disclosed harvester.

FIG. 8 depicts one representative macro-scale industrial embodiment 800. Housing 802 supports spiral cantilever 804, bulk piezoelectric element 806, magnetostrictive member 808, wound pickup coil 810, proof mass 812, mount interface 814, and output electronics 816. FIG. 8 illustrates one representative implementation adapted for machinery, structures, ducts, rotating equipment, or other environments in which persistent or broadband mechanical vibration is available.

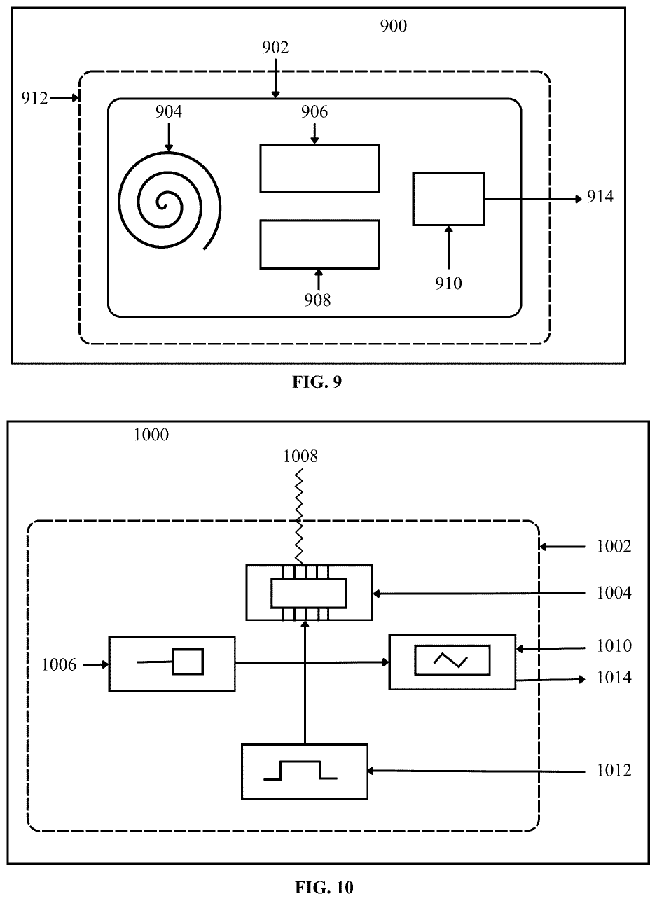

FIG. 9 depicts one representative wearable embodiment 900. Flexible substrate 902 supports flexible spiral cantilever 904, magnetostrictive ribbon 906, piezo layer 908, control electronics 910, body-conformal patch outline 912, and output module or lead 914. FIG. 9 illustrates one representative implementation that may be tuned to walking, running, limb motion, or other biomechanical vibration sources.

FIG. 10 depicts one representative cryogenic embodiment 1000. Cryostat boundary 1002 defines a representative cryogenic operating environment. Quantum processor 1004, co-harvester 1006, cryocooler vibration source 1008, local monitoring circuitry 1010, phase-gate driver 1012, and output isolation path 1014 illustrate one prospective or preferred cryogenic deployment context for the disclosed harvester architecture. FIG. 10 is included to preserve this embodiment as a subordinate application layer and should not be understood as limiting the core invention to cryogenic or quantum-processing use.

With reference to FIG. 1, the cantilever structure 100 may include a clamp region 102 and a cantilever beam 104 extending from the clamp region. In the principal disclosed implementation, cantilever beam 104 follows a logarithmic phi-spiral path in plan view. A proof mass 106 may be positioned at or near a distal portion of the cantilever beam 104 to adjust modal response, lower the effective fundamental frequency, or otherwise tune the dynamic response of the cantilever structure. The cantilever beam 104 may have a beam-width taper profile 108 defined along arc-length path 114 from a base width 116 over a total spiral length 118 between inner radius 110 and outer radius 112. A pitch angle reference 120 may be used to define the spiral geometry, and vibration input direction 122 and one or more mode-antinode regions 124 may be identified for design and validation purposes. In one preferred implementation, the logarithmic spiral may have a pitch angle corresponding to arctan(1/phi), approximately 31.7 degrees. In further representative implementations, the cantilever supports a cascade of modal responses such as f0, f0×phi, f0×phi\hat{ }2, and higher phi-spaced modes, and in one representative example an eight-mode cascade may extend from approximately 20 Hz to approximately 576 Hz, corresponding to a bandwidth ratio of approximately 29:1. Such examples are illustrative of the advantages of phi-spaced modal coverage and do not limit the invention to one exact frequency band.

In a preferred implementation, the beam-width taper is defined by w(s)=w0×phi\hat{ }(−s/L), where w0 is a base width, s is arc length measured along the beam, and L is total spiral length. The values of w0, s, and L may be selected to set a desired stiffness gradient, modal spacing, and target operating band. In other implementations, the exact taper need not follow a single mathematically ideal expression so long as the cantilever structure is configured to support the claimed phi-related multi-mode response. The disclosure therefore uses the logarithmic phi-spiral and taper law as a principal disclosed implementation without requiring every embodiment to be limited to one exact geometric construction. More generally, the broad inventive cantilever family includes cantilever structures configured to exhibit multiple resonant responses, with at least two resonant responses being related by phi, and with the logarithmic phi-spiral providing a preferred and specifically described implementation. Thus, in progressively narrower implementations, the cantilever structure may be characterized as configured to exhibit multiple resonant responses with at least two resonant responses related by phi, as having adjacent modes related by phi, as satisfying f_n=f_0×phi\hat{ }n, as having a logarithmic phi-spiral planform, and as having the taper law w(s)=w0×phi\hat{ }(−s/L).

The cantilever structure is configured to exhibit multiple resonant responses, with at least two resonant responses being related by phi. In a preferred implementation, adjacent resonant responses satisfy f_(n+1)/f_n=phi. In a more specific preferred implementation, resonant mode frequencies satisfy f_n=f_0×phi\hat{ }n, where f_0 is the fundamental frequency and n is a mode index. This modal structure is illustrated conceptually in FIG. 3, in which a frequency-response plot 300 includes a frequency axis 302, a response amplitude axis 304, and representative mode peaks 306, 308, 310, 312, 314, 316, 318, and 320. Overlap region 322, representative Q marker 324, and phi spacing annotation 326 may be used to evaluate whether a particular implementation achieves the intended multi-mode behavior. A person of ordinary skill in the art can select geometry, material, thickness, clamp condition, and proof-mass loading to place the fundamental and higher-order modes within a target vibration band while maintaining the disclosed golden-ratio modal relationship.

Suitable structural materials for the cantilever structure include metals, alloys, semiconducting or micromachined materials, flexible polymeric materials, and other structural materials capable of supporting elastic vibration response. In representative implementations, stainless steel, titanium alloys, silicon, superconducting metals, and flexible polymers may be used. Thickness, radius, proof-mass loading, and clamp geometry may be selected according to intended scale and operating band. For example, a MEMS implementation may use sub-millimeter or millimeter-scale spiral dimensions, while an industrial implementation may use centimeter-scale or larger dimensions. A wearable implementation may use a thinner or more flexible structural material to tune the device to body motion.

With reference to FIG. 2, a transduction stack assembly 200 may include a piezoelectric transducer comprising piezoelectric layer 202 disposed on or coupled to structural substrate 206. FIG. 2 schematically illustrates one arrangement in which the piezoelectric transducer and the magnetostrictive transducer are positioned so as to respond to the same bending event of the cantilever structure. Upper electrode 204 and lower electrode or interface region 208 may be provided so that bending of the cantilever structure generates a charge signal routed through piezoelectric output path 216. The piezoelectric transducer may be implemented as a deposited film, bonded plate, laminated layer, printed material, or other piezoelectric structure mechanically coupled to the cantilever structure. Suitable piezoelectric materials include PZT, AlN, PVDF, PMN-PT, and other piezoelectric materials known in the art. Material selection may be made based on output level, fabrication compatibility, flexibility, environmental compatibility, or integration requirements.

The transduction stack assembly 200 may also include a magnetostrictive transducer comprising magnetostrictive layer 210 or another magnetostrictive member mechanically coupled to structural substrate 206. In response to bending strain in the cantilever structure, the magnetostrictive transducer undergoes a magnetization change that produces a magnetic flux variation along flux path 214. Pickup structure 212 is inductively coupled to the magnetostrictive transducer and converts the magnetic flux variation into an electrical output delivered through magnetostrictive output path 218. The pickup structure may be implemented as a planar spiral coil, a wound coil, an axis-centered coil, an adjacent-substrate coil, or another inductive pickup arrangement capable of receiving the magnetostrictive flux change. Suitable magnetostrictive materials include Terfenol-D, Galfenol, Metglas, FeCoSiB, and other magnetostrictive materials capable of responding to cantilever strain. In representative implementations, the piezoelectric transducer may be formed as a film or layer having thickness on the order of approximately 2 to 20 micrometers, and the magnetostrictive transducer may be formed as a film or layer having thickness on the order of approximately 5 to 50 micrometers. Representative pickup structures may include planar spiral coils on the order of approximately 50 to 100 turns, wound coils, or other inductive structures selected according to scale and output requirements. In further representative implementations, piezoelectric coefficients and magnetostrictive strain-response values may be selected from ranges characteristic of PZT-5H, AlN, PVDF, PMN-PT, Terfenol-D, Galfenol, Metglas, FeCoSiB, or similar materials, according to fabrication compatibility, desired force response, and target operating environment.

A significant feature of the present disclosure is that the piezoelectric transducer and the magnetostrictive transducer are both coupled to a same stress field in the cantilever structure. This is illustrated in FIG. 2 by shared strain field 220 extending through the transduction stack. As shown in FIG. 2, shared strain field 220 causes both the piezoelectric transducer and the magnetostrictive transducer to respond to a same cantilever deformation, thereby enabling dual extraction from a common mechanical event. In the disclosed arrangement, a common bending event in the cantilever structure produces both a piezoelectric charge response and a magnetostrictive flux response. This same-stress arrangement differs from systems in which piezoelectric and magnetostrictive structures are merely co-located or electrically paralleled without being mechanically organized to respond to the same deformation. Because both transduction mechanisms respond to a same stress field, the architecture can extract energy from the same strain event through two distinct physical mechanisms.

The combined output may be represented conceptually by P_total=P_piezo+P_magneto−P_coupling_loss. In representative implementations, coupling loss remains limited because the piezoelectric transduction path and the magnetostrictive transduction path can operate at different effective impedances and may be conditioned separately before energy is accumulated. The disclosure also contemplates a combined efficiency relationship eta_combined=1−(1−eta_piezo)(1−eta_magneto), which expresses the principle that the combined architecture can exceed the performance of either transduction path alone. These expressions are provided to explain the operation of the disclosed arrangement and are not intended to restrict the claimed invention to any single efficiency metric.

In one representative numerical example, where eta_piezo is approximately 0.25 and eta_magneto is approximately 0.35, eta_combined is approximately 0.5125, illustrating that the combined efficiency may exceed either transduction path individually.

Electrical outputs from the piezoelectric and magnetostrictive channels may be separately conditioned or may be combined into a common energy path. The piezoelectric transduction path may include rectification, charge transfer, impedance transformation, storage, filtering, or protective circuitry. The magnetostrictive transduction path may include rectification, inductive conditioning, impedance matching, buffering, filtering, or protective circuitry. In some implementations, both channels may first be conditioned independently and then combined. In other implementations, the channel outputs may be combined at or near an accumulation stage. The core requirement is that the energy extraction circuit receive harvested energy derived from both channels and release output energy only in integer multiples of E_coh, using any suitable accumulation, detection, transfer, and control arrangement consistent with the structural and operational architecture disclosed herein.

With reference to FIG. 4, extraction circuit assembly 400 may receive piezoelectric input 402 and magnetostrictive input 404. The extraction circuit may include an energy accumulator 406, a threshold detector or carry detector 408, a switched-capacitor transfer circuit 410 configured to transfer discrete energy packets according to a phi-based transfer ratio, an optional serializer 412, an optional watchdog 414, an optional eight-tick clock 416, a storage capacitor 418, a regulator 420, a DC output 422, a control bus 424, a disconnect switch 426, a threshold monitor 428, and an accumulator state output 430. Not every implementation requires every illustrated subcomponent, but FIG. 4 illustrates a representative preferred architecture that supports the retained harvester and method claim families.

The energy accumulator 406 may be implemented as a digital, mixed-signal, switched-capacitor, Delta-Sigma, charge-accounting, or other accumulation structure capable of representing accumulated harvested energy. In a preferred implementation, the accumulator has a resolution corresponding to E_coh. Such correspondence may be implemented by scaling the accumulator state, least significant bit, transfer unit, code value, or equivalent energy representation to E_coh. The threshold detector or carry detector 408 monitors the accumulator state and identifies when accumulated harvested energy reaches an integer multiple of E_coh. As shown in FIG. 4, threshold detector or carry detector 408 may receive an accumulator state from accumulator 406 and may generate a release signal when the integer-multiple condition is met. When the release condition is satisfied, the control logic initiates a release event, updates the accumulator state by decrement, subtraction, reset, or transfer, and permits subsequent accumulation to continue from a defined post-release state.

In one representative implementation, the accumulator may be implemented as a Delta-Sigma or other quantized accumulation register having a least significant energy unit corresponding to E_coh. In further representative implementations, a carry detector may subtract one E_coh quantum from the accumulator state upon satisfaction of the release condition and may assert a release-ready signal for transfer to the output stage. By way of example, harvested energy from one or both transduction channels may increment the accumulator during successive vibration cycles until the integer-multiple condition is reached, whereupon the carry detector may generate a release-ready event for immediate transfer or for timed release through the serializer and, when enabled, the eight-tick timing logic.

In one preferred implementation, the switched-capacitor transfer circuit 410 transfers one E_coh packet or a controlled burst of E_coh packets from the accumulator path to the output stage. The transfer relationship may be selected according to phi so that the transfer network conforms to a phi-based switched-capacitor architecture. In representative implementations, the phi-based transfer ratio may be established by capacitor ratios, charge-transfer ratios, scaling of discrete transfer packets, or another equivalent phi-based transfer relationship in a discrete-transfer network. As illustrated in FIG. 4, the switched-capacitor transfer circuit 410 may selectively couple one or more storage nodes, transfer nodes, or charge elements in response to the release signal generated by threshold detector or carry detector 408. In other implementations, another discrete-transfer mechanism may be used so long as the release rule of integer-multiple E_coh transfer is preserved.

Serializer 412, when present, may buffer or sequence a plurality of release events. This may be useful when multiple threshold conditions are satisfied in rapid succession or when output transfer is to be aligned with a selected timing framework. The serializer may be implemented as a FIFO, queue, event register, event counter, burst scheduler, or other sequencing structure. Watchdog 414, when present, may monitor an imbalance condition, threshold condition, release consistency condition, or another operating parameter associated with extraction. If the monitored condition exceeds a selected threshold, the watchdog may inhibit extraction, disconnect the release path, or otherwise suppress one or more release events. Disconnect switch 426 and threshold monitor 428 illustrate representative implementation structures that may be used for this purpose. In representative implementations, an imbalance condition may be determined from accumulator state behavior, packet-transfer consistency, timing consistency, output-stage state, or a comparison between expected and observed release behavior.

In one representative implementation, the serializer may be implemented as a finite-depth event queue, such as a FIFO having capacity for a plurality of release events occurring within a single timing window, thereby permitting controlled burst serialization of multiple E_coh packets. In one representative operating example, if successive release-ready events are generated before a permitted timing window opens, the queue may temporarily store multiple pending events, after which the control logic may transfer a first packet to storage capacitor 418 during a first permitted window and may transfer a second packet during a next permitted window while accumulator 406 continues to accept additional harvested energy from one or both transduction channels. In one representative operating sequence, successive release-ready events may be stored in the queue, transferred one at a time to the output stage, and, when an eight-tick operating mode is enabled, released within selected timing windows while preserving the integer-multiple extraction rule.

Storage capacitor 418 and regulator 420 together provide one representative output stage. In a preferred implementation, storage capacitor 418 receives discrete released energy packets, and regulator 420 conditions the resulting stored energy into a regulated DC output 422 suitable for a load. The output stage may include one or more capacitors, regulators, filters, converters, switches, or protection components. A person of ordinary skill in the art can select a suitable output stage based on target voltage, current, duty cycle, storage requirement, and load profile.

In one representative implementation, the output stage may include a storage capacitor on the order of microfarads, such as approximately 4 microfarads, and a low-dropout regulator configured to produce an output on the order of approximately 1.2 volts. In further representative implementations, quiescent current may be selected in the nanoampere range and cold-start assistance may be provided at sub-volt input levels, such as on the order of approximately 180 millivolts.

In preferred implementations, extraction events are synchronized to an eight-tick cadence. Optional eight-tick clock 416 may define a repeating timing cycle with eight permitted phase positions. When an eight-tick operating mode is enabled, the control logic may permit release events only within one or more selected windows of the eight-tick cadence. The timing framework may be used to align discrete release events, defer release until a permitted timing position occurs, or sequence bursts according to a preferred timing rule. The broadest apparatus and method claims do not require eight-tick timing, but the eight-tick layer remains a preferred narrowing feature that is expressly supported by the disclosure. When present, the timing logic may permit immediate release upon threshold satisfaction, defer release until the next permitted window, or sequence multiple release events across successive permitted windows.

In preferred theoretical framing, the eight-tick timing layer is additionally associated with a cancellation identity over a full eight-position cycle, such that the aggregate phase contribution of a complete cycle sums to zero. This identity is presented as a further rationale for preferred ledger-neutral timing behavior and for reducing perturbation of adjacent sensitive circuitry.

With reference to FIG. 6, a representative method flow 600 includes receiving vibration at step 602, exciting one or more resonant modes at step 604, generating piezoelectric output at step 606, generating magnetostrictive output at step 608, combining channel energy at step 610, accumulating energy at step 612, comparing the accumulator state to an integer-multiple release condition at step 614, releasing one or more E_coh packets at step 616, optionally checking an eight-tick window at step 618, updating watchdog state at step 620, delivering output energy at step 622, and repeating the cycle at step 624. This flowchart provides one representative make-and-use sequence and is not intended to exclude variations in ordering, buffering, timing, or conditioning that preserve the claimed relationships.

Representative embodiments further illustrate how the invention may be made and used. With reference to FIG. 7, a MEMS embodiment 700 may be formed from an SOI wafer 702 or another microfabrication substrate. An etched spiral 704 may define the cantilever geometry. Piezoelectric layer deposition 706, magnetostrictive layer deposition 708, planar coil formation 710, proof mass placement 712, and integration of extraction circuitry 714 may produce a completed die 716. In representative MEMS implementations, the cantilever structure may be tuned to vibrations associated with HVAC equipment, machinery, consumer devices, or infrastructure systems.

In one representative MEMS implementation, overall die dimensions may be on the order of approximately 4 mm×4 mm×0.5 mm, with a three-turn phi-spiral cantilever, thickness on the order of approximately 50 micrometers, and approximately five modal responses within an operating band extending from approximately 80 Hz to approximately 547 Hz.

With reference to FIG. 8, an industrial embodiment 800 may include housing 802, spiral cantilever 804, bulk piezoelectric element 806, magnetostrictive member 808, wound pickup coil 810, proof mass 812, mount interface 814, and output electronics 816. Such embodiments may be mounted to motors, rotating equipment, ducts, structural members, or other industrial systems that provide persistent or broadband mechanical vibration. With reference to FIG. 9, a wearable embodiment 900 may include flexible substrate 902, flexible spiral cantilever 904, magnetostrictive ribbon 906, piezo layer 908, control electronics 910, body-conformal patch outline 912, and output module or lead 914. Such embodiments may be tuned to walking, running, limb motion, or other biomechanical inputs.

In one representative industrial implementation, the device footprint may be on the order of approximately 50 mm in diameter and approximately 30 mm in height, with a five-turn phi-spiral cantilever having thickness on the order of approximately 500 micrometers and approximately eight modes extending from approximately 15 Hz to approximately 576 Hz. In one representative wearable implementation, a flexible patch may be on the order of approximately 30 mm×30 mm×2 mm and may support a fundamental response near approximately 5 Hz with higher modes extending through approximately 89 Hz.

With reference to FIG. 10, a cryogenic embodiment 1000 may be positioned within or adjacent a cryostat boundary 1002 and may be configured to harvest vibration associated with a quantum processor 1004, co-harvester 1006, cryocooler vibration source 1008, local monitoring circuitry 1010, phase-gate driver 1012, and output isolation path 1014. This embodiment is disclosed as a preferred or prospective implementation of the broader architecture and should not be understood as limiting the retained claims to cryogenic or quantum-processing use.

In one representative cryogenic implementation, the cantilever may be tuned to a fundamental response on the order of approximately 1.4 Hz and may deliver harvested power on the order of approximately 1 to 10 microwatts for local monitoring and bias functions.

A person of ordinary skill in the art may select dimensions, materials, proof-mass loading, spiral geometry, transducer type, pickup geometry, accumulator scale, threshold logic, transfer-circuit values, timing logic, and output-stage components according to a target operating band and desired power level. For example, lower-frequency ambient vibration may be addressed by increasing effective cantilever length, increasing proof-mass loading, selecting a more compliant material, or otherwise lowering the effective fundamental frequency. Higher-frequency machinery vibration may be addressed by shortening or stiffening the cantilever structure, reducing proof mass, or selecting a different scale or material. The disclosed phi-related multi-mode framework permits design selection so that multiple resonant modes fall within a target vibration spectrum rather than requiring only a single tuned resonance.

Representative validation may include measurement or simulation of modal frequencies, comparison of adjacent mode ratios to phi, confirmation that the cantilever structure supports the intended number of modes, independent measurement of the piezoelectric and magnetostrictive channel outputs, combined output measurement, and verification that the extraction circuit releases energy only when the accumulator reaches an integer multiple of E_coh. Further validation may include measuring operation of the threshold detector or carry detector, verifying the phi-based transfer ratio of a switched-capacitor transfer network, and confirming discrete packet transfer behavior, testing watchdog response to an imbalance threshold, and testing timing behavior when the optional eight-tick layer is enabled.

In representative numerical examples, a MEMS-scale implementation may provide total output on the order of tens of microwatts under sub-g ambient vibration, and in one representative example approximately 55 microwatts total output at approximately 0.5 g excitation has been associated with a power density on the order of approximately 6,875 microwatts per cubic centimeter. In representative macro-scale industrial implementations, total output may reach the milliwatt to tens-of-milliwatts range under machinery vibration, and in one representative example approximately 50 milliwatts total output has been associated with approximately 1.0 g industrial excitation. In representative cryogenic implementations, E_coh-locked extraction may be associated with added phase noise below approximately 0.5 milliradians and watchdog disconnect times on the order of microseconds. These numerical examples are provided as validation-oriented embodiments and not as claim limitations.

Certain relationships described herein may additionally be supported, in some implementations, by formal verification, numerical analysis, or both. Representative machine-checked support may include verification of the coherence exponent equality yielding exponent 5, uniqueness of the coherence exponent under the stated structural constraint, D=3/eight-tick compatibility, phi-spaced modal progression, phi-based transfer optimality, ledger-neutral extraction relationships, and zero-imbalance safety conditions. Such formal support is presented as supplemental corroboration of the disclosed architecture and supplements, rather than replaces, the structural and operational disclosure set forth herein, which provides the primary basis for the claimed invention.

In some implementations, the coherence quantum, the phi-related modal ladder, and the ledger-neutral timing relationships may be described as constrained relationships within an underlying theoretical framework. Where formal proof artifacts are available, such artifacts may be used as supplemental corroboration of the disclosed physical design rules and operating constraints, but the claimed invention remains grounded primarily in the structural and operational architecture set forth herein.

The invention is not limited to the exact embodiments illustrated and described. Variations in cantilever geometry, material choice, layer ordering, transducer placement, pickup structure, conditioning circuits, accumulation circuits, release circuits, output-stage architecture, packaging, and end use may be employed while remaining within the scope of the invention, provided that the retained claims continue to read on the relevant implementation. For example, the energy accumulator may be digital, analog, mixed-signal, or charge-based; the threshold detector or carry detector may be implemented with comparator-based, digital, mixed-signal, or equivalent logic; the switched-capacitor transfer circuit may be implemented with one or more discrete transfer stages or charge-transfer elements; and the output stage may include one or more storage and regulation elements selected for a desired load profile. In particular, not every embodiment requires every preferred feature described above. The logarithmic phi-spiral, taper law, switched-capacitor transfer circuit configured for phi-based discrete packet transfer, watchdog, and eight-tick timing layer are all expressly disclosed and strategically valuable, but particular claims may recite broader or narrower combinations depending on prosecution requirements.

What is claimed is:

1. A vibration energy harvester comprising: a cantilever structure configured to exhibit multiple resonant responses, wherein at least two resonant responses are related by phi; a piezoelectric transducer mechanically coupled to the cantilever structure; a magnetostrictive transducer mechanically coupled to the cantilever structure such that strain in the cantilever structure induces a magnetization change in the magnetostrictive transducer; a pickup structure inductively coupled to the magnetostrictive transducer; and an energy extraction circuit configured to receive harvested energy from the piezoelectric transducer and the magnetostrictive transducer and to release output energy only when accumulated harvested energy reaches an integer multiple of a coherence quantum E_coh=phi\hat{ }(−5).

2. The vibration energy harvester of claim 1, wherein the piezoelectric transducer and the magnetostrictive transducer are coupled to the same stress field in the cantilever structure.

3. The vibration energy harvester of claim 1, wherein adjacent resonant responses of the cantilever structure have a ratio f_(n+1)/f_n equal to phi.

4. The vibration energy harvester of claim 3, wherein resonant mode frequencies of the cantilever structure satisfy f_n=f_0×phi\hat{ }n.

5. The vibration energy harvester of claim 1, wherein the cantilever structure has a logarithmic phi-spiral planform.

6. The vibration energy harvester of claim 5, wherein a beam width of the cantilever structure varies along arc length according to w(s)=w_0×phi\hat{ }(−s/L).

7. The vibration energy harvester of claim 1, wherein the energy extraction circuit comprises an energy accumulator configured to represent accumulated harvested energy in units corresponding to E_coh.

8. The vibration energy harvester of claim 7, wherein the energy extraction circuit further comprises a threshold detector or carry detector configured to identify when the energy accumulator reaches the integer multiple of E_coh.

9. The vibration energy harvester of claim 1, wherein the energy extraction circuit comprises a switched-capacitor transfer circuit configured to transfer discrete energy packets according to a phi-based transfer ratio.

10. The vibration energy harvester of claim 1, wherein the energy extraction circuit further comprises a watchdog configured to inhibit energy extraction when an imbalance threshold is exceeded.

11. The vibration energy harvester of claim 1, wherein release events are synchronized to an eight-tick cadence.

12. The vibration energy harvester of claim 1, further comprising an output stage including a storage capacitor and a regulator configured to receive energy released by the energy extraction circuit.

13. The vibration energy harvester of claim 1, wherein the piezoelectric transducer comprises PZT, AlN, PVDF, or PMN-PT, and the magnetostrictive transducer comprises Terfenol-D, Galfenol, Metglas, or FeCoSiB.

14. The vibration energy harvester of claim 1, wherein the energy extraction circuit further comprises a serializer or queue configured to sequence a plurality of release events.

15. The vibration energy harvester of claim 1, wherein the cantilever structure, the piezoelectric transducer, the magnetostrictive transducer, and the pickup structure are implemented in a MEMS-scale device.

16. The vibration energy harvester of claim 1, wherein the cantilever structure comprises a flexible substrate configured for harvesting biomechanical vibration.

17. A method of harvesting vibration energy, comprising: coupling a cantilever structure to a vibration source, the cantilever structure being configured to exhibit multiple resonant responses, wherein at least two resonant responses are related by phi; converting strain in the cantilever structure through a piezoelectric transduction path and a magnetostrictive transduction path;
inductively sensing a magnetostrictive output through a pickup structure; accumulating harvested energy from the piezoelectric transduction path and the magnetostrictive transduction path; and
releasing output energy only when accumulated harvested energy reaches an integer multiple of a coherence quantum E_coh=phi\hat{ }(−5).

18. The method of claim 17, wherein the piezoelectric transduction path and the magnetostrictive transduction path respond to the same stress field in the cantilever structure.

19. The method of claim 17, wherein releasing output energy comprises detecting that an energy accumulator state has reached the integer multiple of E_coh.

20. The method of claim 17, wherein releasing output energy further comprises sequencing a plurality of release events through a serializer or queue and releasing within a permitted window of an eight-tick cadence.
